(19) United States
(12) Patent Application Publication
(10) Pub. No.: US 2024/0347730 A1
(43) Pub. Date: Oct. 17, 2024

(54) NEGATIVE ACTIVE MATERIAL AND RECHARGEABLE LITHIUM BATTERY INCLUDING SAME

(71) Applicant: SAMSUNG SDI CO., LTD., Yongin-si (KR)

(72) Inventors: Narae KIM, Yongin-si (KR); Yurim CHA, Yongin-si (KR); Seyoung OH, Yongin-si (KR); Deok-Hyun KIM, Yongin-si (KR); Chungku YEO, Yongin-si (KR)

(21) Appl. No.: 18/487,897

(22) Filed: Oct. 16, 2023

(30) Foreign Application Priority Data
Apr. 17, 2023 (KR) 10-2023-0050154

(51) Int. Cl. H01M 4/587; C01B 32/21; H01M 4/133; H01M 10/052

(52) U.S. Cl. CPC H01M 4/587; C01B 32/21; H01M 4/133; H01M 4/1393; H01M 10/052; C01B 2204/22; C01P 2002/74; C01P 2004/03; C01P 2004/50; C01P 2004/61; C01P 2004/62; C01P 2006/40; H01M 2004/027

(57) ABSTRACT

A negative active material and a rechargeable lithium battery including the same are provided. The negative active material includes (e.g., consists of) an amorphous carbon material, low crystalline graphite particles and pores within the amorphous carbon material and/or the low crystalline graphite particles, wherein a ratio of a cross-sectional area of the pores relative to a cross-sectional area of the negative active material is about 4% to about 10%.

### CROSS-REFERENCE TO RELATED APPLICATION

The present application claims priority to and the benefit of Korean Patent Application No. 10-2023-0050154, filed on Apr. 17, 2023, in the Korean Intellectual Property Office, the entire content of which is incorporated herein by reference.

### BACKGROUND

### 1. Field

Embodiments of this disclosure relates to a negative active material and a rechargeable lithium battery including the same.

### 2. Description of the Related Art

Recently, the rapid increase in demand for electronic devices utilizing batteries, such as mobile phones, laptop computers, and/or electric vehicles, caused an increase in demand or desire for rechargeable batteries with relatively high capacity and lighter weight. For example, a rechargeable lithium battery has recently drawn attention as a driving power source for portable devices, as it has relatively lighter weight and high energy density. However, researches for improving performances of rechargeable lithium batteries are still desired and/or actively conducted.

Rechargeable lithium batteries include a positive electrode and a negative electrode, each including an active material capable of intercalating and deintercalating lithium ions, and an electrolyte, and generate electrical energy due to the oxidation and reduction reaction happened when lithium ions are intercalated and deintercalated into the positive electrode and the negative electrode.

As a positive active material for a rechargeable lithium battery, transition metal compounds, such as a lithium cobalt oxide, a lithium nickel oxide, a lithium manganese oxide, and/or the like, have been utilized. As a negative active material, crystalline-based carbonaceous materials, such as natural graphite, artificial graphite, amorphous carbonaceous material, and/or silicon-based active material (such as Si), have been utilized.

Among these, artificial graphite provides relatively high power and long cycle-life. However, in consideration of cost and suitability, natural graphite, which is economical and has excellent or suitable capacity, has been utilized to meet the continuous increase in demand for the rechargeable battery. However, the flaky natural graphite, which has been utilized, has narrower d002 and higher crystallinity than artificial graphite, resulting in a slower rate of intercalation and deintercalation of lithium ions, and thus, high power characteristics which is required or desirable may not be satisfied.

### SUMMARY

An aspect according to one or more embodiments is directed toward a negative active material exhibiting improved high power characteristics.

An aspect according to one or more embodiments is directed toward a rechargeable lithium battery including the negative active material. Additional aspects will be set forth in part in the description which follows and, in part, will be apparent from the description, or may be learned by practice of the presented embodiments of the disclosure.

According to one or more embodiments, a negative active material consists of an amorphous carbon material, low crystalline graphite particles, and pores, wherein the amorphous carbon material is around the low crystalline graphite particles and the pores, and a ratio of a cross-sectional area of the pores relative to a cross-sectional area of the negative active material is about 4% to about 10%.

The negative active material may have a peak intensity ratio, I(002)/I(110) measured by an X-ray diffraction analysis method of about 120 or less, or about 70 to about 120.

The negative active material may be a form of particles having an average particle size of about 10 μm to about 25 μm.

The low crystalline graphite may be derived from amorphous graphite.

The negative active material may be prepared by: pulverizing amorphous graphite to prepare graphite particulates, agglomerating the graphite particulates by utilizing amorphous carbon to prepare an agglomerated product; and mixing the agglomerated product with a pore-forming agent to form the pores. The graphite particulates may have an average particle size of about 10 μm or less, the graphite particulate may have an average particle size of about 0.1 μm to about 10 μm.

The pore-forming agent may be an alkali-based activator.

The pore-forming agent may be about 1 wt % to about 5 wt % in amount based on 100 wt % of the agglomerated product.

According to an embodiment, a rechargeable lithium battery includes a negative electrode including the negative active material, a positive electrode, and an electrolyte.

A negative active material according to one or more embodiments may exhibit excellent or suitable cycle-life characteristics and high rate characteristics.

### BRIEF DESCRIPTION OF THE DRAWINGS

The above and other aspects, features, and enhancements of certain embodiments of the disclosure will be more apparent from the following description taken in conjunction with the accompanying drawings, in which:

FIG. 1 schematically shows the structure of a negative active material according to some embodiments;

FIG. 2 is a schematic diagram showing a rechargeable lithium battery according to one or more embodiments; and

FIG. 3 is a scanning electron microscope (SEM) image of the negative active material layer of the negative electrode obtained after charging and discharging the half-cell according to Example 1.

### DETAILED DESCRIPTION

Hereinafter, embodiments of the present disclosure are described in more detail. However, these embodiments are merely examples, the present disclosure is not limited thereto, and the scope of the present disclosure is defined by the claims and equivalents thereof.

In the present disclosure, when particles are spherical, “diameter” indicates a particle diameter or an average particle diameter, and when the particles are non-spherical, the “diameter” indicates a major axis length or an average major axis length. In the present disclosure, when a definition is not otherwise provided, a particle diameter indicates an average particle diameter or size (D50) corresponding to a cumulative volume of about 50 volume % in a particle size distribution. The average particle size (D50) may be measured by a suitable method (e.g., known to those skilled in the art), for example, by a particle size analyzer, by a transmission electron microscopic image, and/or a scanning electron microscopic image. In some embodiments, a dynamic light-scattering measurement device is utilized to perform a data analysis, and the number of particles is counted for each particle size range, and from this, the average particle diameter (D50) value may be easily obtained through calculation.

A negative active material according to one or more embodiments includes (e.g., consists of) an amorphous carbon material, low crystalline graphite, and pores, with the amorphous carbon material enclosing (e.g., around, surrounding, including, etc.) the low crystalline graphite and pores, and an area ratio, which is a ratio of a cross-sectional area of the pores relative to a cross-sectional area of the negative active material (e.g., a sum of the cross-sectional area of the pores, the cross-sectional area of the amorphous carbon material and the cross-sectional area of the low crystalline graphite), is about 4% to about 10%.

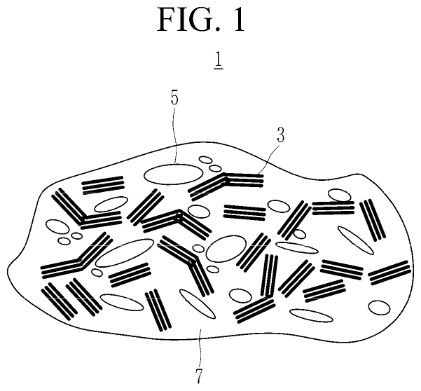

The cross-sectional area indicates the area of the cut portion, if (e.g., when) the negative active material or pores are cut into one plane or cross-section, and the cross-sectional area of the pores indicates the sum of the cross-sectional areas of pores (e.g., all pores) included in the negative active material (e.g., a single negative active material particle in FIG. 1).

If (e.g., when) the area ratio satisfies this range, a diffusion distance of lithium ions may be reduced to readily move lithium ions during charging and discharging, thereby improving high rate charge and discharge characteristics. If (e.g., when) the area ratio exceeds this range, the negative active material may not provide sufficient lithium ion mobility (e.g., not sufficient to move lithium ions).

In one or more embodiments, the area ratio is obtained from the cross-section of the negative active material, and is a ratio of the area the pores occupy with respect to 100% of the total area of the negative active material. For example, a SEM image which is treated by a cross-section CP (cross-section polishing) of the negative active material is taken, so that high brightness, brighter regions in the measured SEM image may be classified as carbonaceous, and low brightness, darker regions may be classified into pores. The area of each region and the area of the total active material may be measured by utilizing the Image J program, or alternatively, may be measured by other suitable equipment or programs capable of measuring areas, other than the Image J analysis tool.

The area ratio is a ratio that accounts for the area all substantial pores included in the negative active material occupy, and it is a value different from porosity measured by a general mercury intrusion porosimetry. The mercury intrusion porosimetry measures the size and volume of the pores, for example, porosity, by the amount of mercury inserted into the pores according to the pressure. Thus, in the porosity measured by mercury intrusion porosimetry, fine pores into which mercury is not inserted are excluded from the measurement, but the area ratio according to one or more embodiments measured by this procedure may include all pores in the measurement.

For example, assuming the negative active material and pores are spherical in shape, if (e.g., when) the area ratio, which is a ratio of a cross-sectional area of the pores relative to a cross-sectional area of the negative active material, being about 4% to about 10% is converted into a porosity in volume %, it should be about or approximately 0.8% to about 3.16%.

The negative active material according to one or more embodiments is prepared by agglomerating the low crystalline graphite in the form of low crystalline graphite particles (i.e., agglomerating low crystalline graphite particles) with amorphous carbon, for example, by agglomerating low crystalline graphite particle primary particles with the amorphous carbon. In some embodiments, low crystalline graphite primary particles may be agglomerated and amorphous carbon may be present on a surface of the primary particles, and an amorphous carbon coating layer around (e.g., surrounding) the secondary particles in which primary particles are agglomerated, may be positioned. Such a negative active material may include low crystalline graphite particles and pores included in an amorphous carbon matrix.

In one or embodiments, if (e.g., when) the negative active material includes secondary particles in which primary particles are agglomerated, pores may be included inside the negative active material, for example, inside the (e.g., inside each of) secondary particles. Such pores may be formed by a pore-forming agent.

The particle diameter of the primary particles may be about 10 μm or less, or about 0.1 μm to about 10 μm. The secondary particle may have a particle diameter of about 8 μm to about 40 μm. In one or more embodiments, if (e.g., when) the particle diameter of the primary particle is 10 μm or less, the particle diameter of the secondary particles that are formed by agglomeration of such primary particles may be any suitable size.

In some embodiments, the secondary particle is formed by agglomerating a plurality of primary particles. The number of the agglomerated primary particles is not particularly limited, but the secondary particle may be formed by gathering, for example, about 2 to about 50, about 2 to about 40, about 2 to about 30, about 2 to about 20, about 2 to about 10, or about 2 to about 4 primary particles.

In the negative active material, a mixing ratio of the low crystalline carbon and amorphous carbon may be about 90:10 to about 75:25 by weight ratio, for example, about 90:10 to about 80:20 by weight ratio, about 90:10 to about 85:15 by weight ratio, or about 90:10 to about 88:12 by weight ratio. If (e.g., when) the mixing ratio of the low crystalline carbon and amorphous carbon is within these ranges, the side reaction with the electrolyte may be more effectively suppressed or reduced and charge and discharge rate capability may be further improved.

The negative active material may have a peak intensity ratio I(002)/I(110) of less than or equal to about 120, for example, about 70 to about 120, about 80 to about 110, or about 90 to about 100 when measured by a X-ray diffraction (XRD) utilizing a CuKα ray. The peak intensity ratio, I(002)/I(110), if (e.g., when) within these ranges indicates a high degree of non-orientation, which indicates low crystallinity. Such a low crystalline may render (or cause) readily intercalation and deintercalation of lithium ions, thereby improving high-rate characteristics.

In one or more embodiments, I(110) is a peak intensity value at a (110) plane, when an XRD is measured by utilizing a CuKα ray, and I(002) is a peak intensity value at a (002) plane, when an XRD is measured by utilizing a CuKα ray. In general, peak intensity indicates a height of a peak or an integral area of the peak, and according to one or more embodiments, the peak intensity indicates the integral area of a peak. The peak intensity is measured by removing a monochromator equipment in order to improve a peak intensity resolution. The measurement was performed under a condition of 20=about 20° to about 80°, a scan speed (°/S)=about 0.030 to about 0.089, and a step size (°/step) of about 0.013 to about 0.039.

In one or more embodiments, the negative active material in a form of a plurality of particles may have a size (e.g., an average particle size D50) of about 10 μm to about 25 μm, or about 15 μm to about 25 μm.

The low crystalline graphite may be derived from amorphous graphite (e.g., fine flake graphite). For example, the low crystalline graphite may be prepared by utilizing amorphous graphite, and may include graphene from the amorphous graphite that has been pulverized to have a short length.

The amorphous carbon may be soft carbon, hard carbon, mesophase pitch carbide, sintered cokes, or a combination thereof.

The negative active material according to one or more embodiments may be prepared by the following procedures.

First, amorphous graphitemay be pulverized to prepare graphite particulates (or particles). A particle diameter, e.g., an average size of the graphite particulates may be about 10 μm or less, or about 0.1 μm to about 10 μm. If (e.g., when) the average size of the graphite particulates obtained through the pulverization is less than 10 μm, the path for lithium ion diffusion may be further shortened, so that high power characteristics may be improved.

The pulverization may be performed by utilizing a jet mill procedure to pulverize amorphous graphite into graphite particulates with about 10 μm or less.

The preparation of graphite particulates may be performed by utilizing amorphous graphite, for example, amorphous graphite of which crystallinity is low (low crystalline graphite), so that the speed of deintercalating and intercalating lithium ions may be improved.

The graphite particulates may be mixed with an amorphous carbon precursor and the resulting mixture may be heat-treated to perform agglomeration. According to the heat-treatment, the amorphous carbon precursor may be converted into amorphous carbon.

The amorphous carbon precursor may be one selected from among a phenolic resin, a furan resin, an epoxy resin, polyacrylonitrile, a polyamide resin, a polyimide resin, a polyamideimide resin, synthetic pitch, petroleum-based pitch, coal-based pitch, meso pitch, tar, or a combination thereof.

In the mixing, a mixing ratio may be adjusted to have a weight ratio of graphite particulate and amorphous carbon to be about 95:5 to 80:20 by weight ratio, for example, 95:5 to 85:15 by weight ratio, 95:5 to 90:10 by weight ratio, or 95:5 to 93:7 by weight ratio.

The heat-treatment may be carried out at about 600° C. to about 1000° C.

In agglomerating, graphite particulates, for example, graphite primary particles may be agglomerated to prepare a secondary particle, thereby preparing an agglomerated product. Amorphous carbon may be positioned on a surface of the primary particles and may be also on a surface of the secondary particle, so that it may be positioned as an amorphous carbon-included coating layer.

Thereafter, the resulting agglomerated product may be mixed with a pore-forming agent to form pores. The pore-forming agent may be an alkali-based activator, and for example, may be KOH, NaOH, or a combination thereof. An amount of the pore-forming agent may be about 1 wt % to about 5 wt % based on 100 wt % of the agglomerated product. After mixing the pore-forming agent, a heat-treatment may be carried out at about 700° C. to about 900° C. Thereafter, the heat-treated product may be washed to remove the pore-forming agent, thereby forming pores. The washing may be performed by utilizing water, an alcohol, or a combination thereof, and the alcohol may be methanol, ethanol, propanol, or a combination thereof. If (e.g., when) water and alcohol are mixed, a mixing ratio may be suitably adjusted.

According to this procedure, a negative active material including (e.g., consisting of) an amorphous carbon matrix around (e.g., including) low crystalline graphite and pores, may be prepared.

FIG. 1 schematically shows the structure of the negative active material according to one or more embodiments. As shown in FIG. 1, the negative active material 1 includes low crystalline graphite 3, pores 5, and amorphous carbon 7 (for example, forming an amorphous carbon matrix), and the low crystalline graphite 3 includes graphenes included in amorphous graphite that have been pulverized to distribute at a shorter length. In FIG. 1, pores 5 are shown to exist in (e.g., inside) amorphous carbon 7, but FIG. 1 is a schematic view, and does not limit the pores to exist only in (e.g., inside) amorphous carbon 7. For example, pores 5 may exist not only in amorphous carbon 7, but also in low crystalline graphite 3.

The negative active material according to one or more embodiments may be applicable for a negative active material for a rechargeable lithium battery.

Another embodiment provides a rechargeable lithium battery including a negative electrode, a positive electrode, and a non-aqueous electrolyte.

The negative electrode includes a negative active material layer including the negative active material according to one or more embodiments, a binder, and optionally, a conductive material, and a current collector supporting the negative active material layer.

In the negative active material layer, the amount of the negative active material may be about 95 wt % to about 98 wt % based on the total 100 wt % of the negative active material layer.

An amount of the binder may be about 1 wt % to about 5 wt % based on the total 100 wt % of the negative active material layer.

If (e.g., when) the negative active material layer further includes the conductive material, an amount of the negative active material may be about 90 wt % to about 99 wt % based on the total 100 wt % of the negative active material layer, and amounts of the binder and the conductive material may be, respectively, about 1 wt % to about 5 wt % based on the total 100 wt % of the negative active material layer.

The binder improves binding properties of negative active material particles with one another and with a current collector. The binder may be a non-aqueous binder, an aqueous binder, or a combination thereof.

The non-aqueous binder may be an ethylene propylene copolymer, polyacrylonitrile, polystyrene, polyvinylchloride, carboxylated polyvinylchloride, polyvinyl fluoride, polyurethane, polytetrafluoroethylene, polyvinylidene fluoride, polyethylene, polypropylene, polyamide imide, polyimide, or combinations thereof.

The aqueous binder may be a styrene-butadiene rubber, an acrylated styrene-butadiene rubber (ABR), an acrylonitrile-butadiene rubber, an acrylic rubber, a butyl rubber, a fluorine rubber, an ethylene oxide-containing polymer, polyvinyl pyrrolidone, polypropylene, polyepichlorohydrin, polyphosphazene, an ethylene propylene diene copolymer, polyvinyl pyridine, chlorosulfonated polyethylene, latex, a polyester resin, an acrylic resin, a phenolic resin, an epoxy resin, polyvinyl alcohol, or combinations thereof.

If (e.g., when) the aqueous binder is utilized as a negative electrode binder, a cellulose-based compound may be further utilized to provide viscosity. The cellulose-based compound includes one or more of carboxymethyl cellulose, hydroxypropylmethyl cellulose, methyl cellulose, or alkali metal salts thereof. The alkali metal may be Na, K, and/or Li. The thickener may be included in an amount of about 0.1 parts by weight to about 3 parts by weight based on 100 parts by weight of the negative active material.

The conductive material is included to provide electrode conductivity, and any electrically conductive material may be utilized as a conductive material unless it causes a chemical change. Examples of the conductive material may be a carbon-based material such as natural graphite, artificial graphite, carbon black, acetylene black, ketjen black, a carbon fiber, and/or the like; a metal-based material of a metal powder or a metal fiber including copper, nickel, aluminum, silver, and/or the like; a conductive polymer such as a polyphenylene derivative; or a mixture thereof.

The current collector may include one selected from among a copper foil, a nickel foil, a stainless steel foil, a titanium foil, a nickel foam, a copper foam, a polymer substrate coated with a conductive metal, and combinations thereof, but is not limited thereto.

The positive electrode may include a current collector and a positive active material layer formed on the current collector.

The positive electrode active material may include lithiated intercalation compounds that can reversibly intercalate and deintercalate lithium ions. In some embodiments, one or more composite oxides of a metal selected from among cobalt, manganese, nickel, and combinations thereof, and lithium, may be utilized. For example, the compounds represented by one or more of the following chemical formulae may be utilized: LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}CO_{b}X_{c}Dₐ (0.90≤a≤1.8, 0≤b≤0.5, 0≤c≤0.5, 0<a≤2); LiₐNi_{1-b-c}CO_{b}X_{c}O₂₋ₐTₐ (0.90≤a≤1.8, 0≤b≤0.5, 0≤c≤0.5, 0<a<2); LiₐNi_{1-b-c}CO_{b}X_{c}O₂₋ₐT₂ (0.90≤a≤1.8, 0≤b≤0.5, 0≤c≤0.5, 0≤a≤2); LiₐNi_{1-b-c}Mn_{b}X_{c}Dₐ (0.90≤a≤1.8, 0≤b≤0.5, 0≤c≤0.5, 0≤a≤2); LiₐNi_{1-b-c}Mn_{b}X_{c}O₂₋ₐTₐ (0.90≤a≤1.8, 0≤b≤0.5, 0≤c≤0.5, 0≤a≤2); LiₐNi_{1-b-c}Mn_{b}X_{c}O₂₋ₐT₂ (0.90≤a≤1.8, 0≤b≤0.5, 0≤c≤0.5, 0≤a≤2); LiₐNi_{b}E_{c}G_{d}O₂ (0.90≤a≤1.8, 0≤b≤0.9, 0≤c≤0.5, 0.001≤d≤0.1); LiₐNi_{b}COMnₐGₑO₂ (0.90≤a≤1.8, 0≤b≤0.9, 0≤c≤0.5, 0≤d≤0.5, 0≤e≤0.1); LiₐNi_{b}Co_{c}Al_{d}GₑO₂ (0.90≤a≤1.8, 0≤b≤0.9, 0≤c≤0.5, 0≤d≤0.5, 0≤e≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); and LiₐFePO₄ (0.90≤a≤1.8).

In the above chemical formulae, A is selected from among Ni, Co, Mn, and combinations thereof thereof; X is selected from among Al, Ni, Co, Mn, Cr, Fe, Mg, Sr, V, a rare earth element, and combinations thereof; D is selected from among O, F, S, P, and combinations thereof; E is selected from among Co, Mn, and a combination thereof; T is selected from among F, S, P, and combinations thereof; G is selected from among Al, Cr, Mn, Fe, Mg, La, Ce, Sr, V, and combinations thereof; Q is selected from among Ti, Mo, Mn, and combinations thereof; Z is selected from among Cr, V, Fe, Sc, Y, and combinations thereof; J is selected from among V, Cr, Mn, Co, Ni, Cu, and combinations thereof.

The compounds may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture (or combination) thereof. The coating layer may be disposed through a method having no (substantially) adverse influence on properties of the positive electrode active material by utilizing these elements in the compound. For example, the method may include any suitable coating method, such as spray coating, dipping, and/or the like, but is not illustrated in more detail because it is known in the related field.

In the positive electrode, an amount of the positive active material may be about 90 wt % to about 98 wt % based on the total weight of the positive active material layer.

In one or embodiments, the positive active material layer may further include a binder and a conductive material. The binder and the conductive material may be included in an amount of about 1 wt % to about 5 wt %, respectively, based on the total amount of the positive active material layer.

The binder improves binding properties of positive active material particles with one another and with a current collector. Non-limiting examples of the binder may include (e.g., may be) polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinyl pyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like.

The conductive material is included to provide electrode conductivity, and any electrically conductive material may be utilized as a conductive material unless it causes a chemical change. Examples of the conductive material may include a carbon-based material such as natural graphite, artificial graphite, carbon black, acetylene black, ketjen black, a carbon fiber and/or the like; a metal-based material of a metal powder or a metal fiber including copper, nickel, aluminum, silver, and/or the like; a conductive polymer such as a polyphenylene derivative; or a mixture thereof.

The current collector may include Al, but is not limited thereto.

The electrolyte includes a non-aqueous organic solvent and a lithium salt.

The non-aqueous organic solvent serves as a medium for transmitting (e.g., transporting) ions taking part in the electrochemical reaction of a battery.

The non-aqueous organic solvent may include a carbonate-based, ester-based, ether-based, ketone-based, alcohol-based, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, propyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. The ketone-based solvent may include cyclohexanone, and/or the like. The alcohol-based solvent may include ethyl alcohol, isopropyl alcohol, and/or the like, and examples of the aprotic solvent may include one or more nitriles such as R-CN (where R is a C2 to C20 linear, branched, or cyclic hydrocarbon, and may include a double bond, an aromatic ring, and/or an ether bond), amides such as dimethylformamide, dioxolanes such as 1,3-dioxolane, sulfolanes, and/or the like.

The organic solvent may be utilized alone or in a mixture. If (e.g., when) the organic solvent is utilized in a mixture, the mixing ratio may be controlled or selected in accordance with a desirable battery performance, and it may be any suitable one known to those skilled in the related art.

The carbonate-based solvent may include a mixture of a cyclic carbonate and a linear carbonate. The cyclic carbonate and the linear carbonate may be mixed together in a volume ratio of about 1:1 to about 1:9, and if (e.g., when) the mixture is utilized as an electrolyte, it may have enhanced performance.

The organic solvent may further include an aromatic hydrocarbon-based solvent as well as the carbonate-based solvent. The carbonate-based solvent and aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 1.

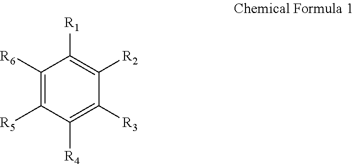

1 In Chemical Formula 1, R₁ to R₆ may each independently be the same or different and may be selected from among hydrogen, a halogen, a C1 to C10 alkyl group, a haloalkyl group, and combinations thereof.

Examples of the aromatic hydrocarbon-based organic solvent may be selected from among benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and combinations thereof.

The electrolyte may further include vinylethyl carbonate, vinylene carbonate, and/or an ethylene carbonate-based compound represented by Chemical Formula 2 as an additive for improving cycle life.

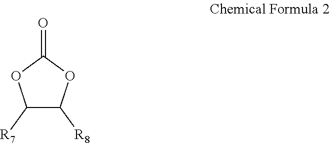

In Chemical Formula 2, R₇ and R₈ may each independently be the same or different and may each independently be hydrogen, a halogen, a cyano group (CN), a nitro group (NO₂), or a C1 to C5 fluoroalkyl group, provided that at least one of R₇ or R₈ is a halogen, a cyano group (CN), a nitro group (NO₂), or a C1 to C5 fluoroalkyl group, and R₇ and R₈ are not concurrently (e.g., not each or simultaneously) hydrogen.

Examples of the ethylene carbonate-based compound may include (e.g., may be) difluoro ethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and/or the like. An amount of the additive for improving the cycle-life characteristics may be utilized within an appropriate or suitable range.

The lithium salt dissolved in an organic solvent supplies a battery with lithium ions, enables the basic operation of the rechargeable lithium battery, and improves transportation of the lithium ions between a positive electrode and a negative electrode. Examples of the lithium salt may include one or more (e.g., two) supporting salts selected from among LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein x and y are natural numbers, for example, an integer of about 1 to about 20, lithium difluoro (bisoxolato) phosphate), LiCl, LiI, LiB(C₂O₄)₂ (lithium bis(oxalato) borate: LiBOB) and lithium difluoro (oxalato) borate. A concentration of the lithium salt may range from about 0.1 M to about 2.0 M. If (e.g., when) the lithium salt is included at the above concentration range, an electrolyte may have excellent or suitable performance and lithium ion mobility due to optimal or suitable electrolyte conductivity and viscosity.

A separator may be disposed between the positive electrode and the negative electrode depending on a type or kind of a rechargeable lithium battery. The separator may utilize polyethylene, polypropylene, polyvinylidene fluoride, or multi-layers thereof having two or more layers and may be a mixed multilayer such as a polyethylene/polypropylene double-layered separator, a polyethylene/polypropylene/polyethylene triple-layered separator, a polypropylene/polyethylene/polypropylene triple-layered separator, and/or the like.

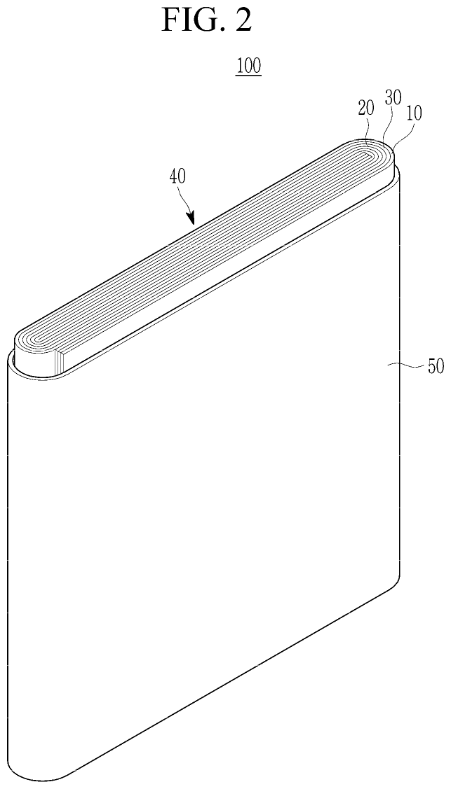

FIG. 2 is an exploded perspective view of a rechargeable lithium battery according to an embodiment. The rechargeable lithium battery according to some embodiments is illustrated as a prismatic battery but is not limited thereto and may include variously-shaped batteries such as a cylindrical battery, a pouch battery, and/or the like.

Referring to FIG. 2, a rechargeable lithium battery 100 according to an embodiment may include an electrode assembly 40 manufactured by winding a separator 30 disposed between a positive electrode 10 and a negative electrode 20 and a case 50 housing the electrode assembly 40. An electrolyte may be impregnated in the positive electrode 10, the negative electrode 20 and the separator 30.

Hereinafter, examples of the present disclosure and comparative examples are described. These examples, however, are not in any sense to be interpreted as limiting the scope of the present disclosure.

### Example 1

Amorphous graphite was pulverized by a jet mill process to prepare low crystalline graphite primary particles having an average particle diameter, D50 of 5 μm.

An agglomeration was carried out, which includes mixing the low crystalline graphite primary particles and a petroleum pitch in order to have a weight ratio of the low crystalline graphite primary particles and soft carbon (e.g., the petroleum pitch) to be 93:7, and then heat-treating the resulting mixture at 800° C. to prepare an agglomerated product of the low crystallin graphite secondary particles (each with a agglomeration their respective low crystalline graphite primary particles) and soft carbon.

The agglomerated product was mixed with KOH, and then heat-treated at 800° C. Herein, the alkali-based activator (e.g., KOH) was utilized at an amount of 4 wt % based on 100 wt % of the agglomerated product. Thereafter, the heat-treated product was washed with a mixed solvent of distilled water and ethanol (10:90 by volume ratio) to remove KOH, thereby forming pores, so that a negative active material having an average particle diameter (D50) of 22 μm, and including low crystalline graphite, pores, and a soft carbon matrix, was prepared.

In the prepared negative active material, a mixing ratio of the low crystalline graphite and soft carbon was at a weight ratio of 93:7 and the average size (e.g., diameter) of the pores was 0.5 μm. In the present disclosure, when pores are spherical or circular, “diameter” or “size” indicates a sphere or circle diameter or an average sphere or circle diameter, and when the pores are non-spherical or circular, the “diameter” or “size” indicates a major axis length or an average major axis length.

97.5 wt % of the negative active material, 1.5 wt % of a styrene-butadiene rubber binder, and 1.0 wt % of a carboxymethyl cellulose thickener were mixed in a water solvent to prepare a negative active material slurry.

The negative active material slurry was coated on a Cu foil current collector, dried and pressurized under a general procedure to prepare a negative electrode including the current collector and a negative active material layer formed on the current collector.

Utilizing the negative electrode, a lithium metal counter electrode, and an electrolyte, a coin-type or kind half-cell was fabricated. The electrolyte utilized was a 1.5 M LiPF₆ dissolved in a mixed solvent of ethylene carbonate, ethylmethyl carbonate and dimethyl carbonate (20:10:70 volume ratio).

### Example 2

A negative active material in a form of particles having an average diameter (D50) of 22 μm and including low crystalline carbon, pores and a soft carbon matrix was prepared by the same procedure as in Example 1, except that an amount of KOH was changed into 1 wt % based on 100 wt % of the agglomerated product.

Utilizing the negative active material, a negative electrode and a coin-type or kind half-cell were fabricated by the same procedure as in Example 1.

### Example 3

A negative active material having an average diameter (D50) of 22 μm and including low crystalline carbon, pores and a soft carbon matrix was prepared by the same procedure as in Example 1, except that an amount of KOH was changed into 2 wt % based on 100 wt % of the agglomerated product.

Utilizing the negative active material, a negative electrode and a coin-type or kind half-cell were fabricated by the same procedure as in Example 1.

### Example 4

A negative active material having an average diameter (D50) of 22 μm and including low crystalline carbon, pores and a soft carbon matrix was prepared by the same procedure as in Example 1, except that an amount of KOH was changed into 3 wt % based on 100 wt % of the agglomerated product.

Utilizing the negative active material, a negative electrode and a coin-type or kind half-cell were fabricated by the same procedure as in Example 1.

### Example 5

A negative active material having an average diameter (D50) of 22 μm and including low crystalline carbon, pores and a soft carbon matrix was prepared by the same procedure as in Example 1, except that an amount of KOH was changed into 5 wt % based on 100 wt % of the agglomerated product.

Utilizing the negative active material, a negative electrode and a coin-type or kind half-cell were fabricated by the same procedure as in Example 1.

### Comparative Example 1

A negative active material having an average diameter (D50) of 20.4 μm was prepared by the same procedure as in Example 1, except that flake graphite was utilized instead of amorphous graphite and graphite primary particles and petroleum-based pitch were mixed in order to obtain graphite primary particles and soft carbon to be a weight ratio of 93:7.

Utilizing the negative active material, a negative electrode and a coin-type or kind half-cell were fabricated by the same procedure as in Example 1.

### Comparative Example 2

A negative active material having an average diameter (D50) of 22 μm and including low crystalline carbon, pores and a soft carbon matrix was prepared by the same procedure as in Example 1, except that an amount of KOH was changed into 0.5 wt % based on 100 wt % of the agglomerated product.

Utilizing the negative active material, a negative electrode and a coin-type or kind half-cell were fabricated by the same procedure as in Example 1.

### Comparative Example 3

A negative active material having an average diameter (D50) of 22 μm and including low crystalline carbon, pores and a soft carbon matrix was prepared by the same procedure as in Example 1, except that an amount of KOH was changed into 6 wt % based on 100 wt % of the agglomerated product.

Utilizing the negative active material, a negative electrode and a coin-type or kind half-cell were fabricated by the same procedure as in Example 1.

### Comparative Example 4

A negative electrode and a half-cell were fabricated by the same procedure as in Example 1, except that the agglomerated product prepared by Example 1 was utilized (e.g., solely) as a negative active material.

### Experimental Example 1) Measurement of SEM

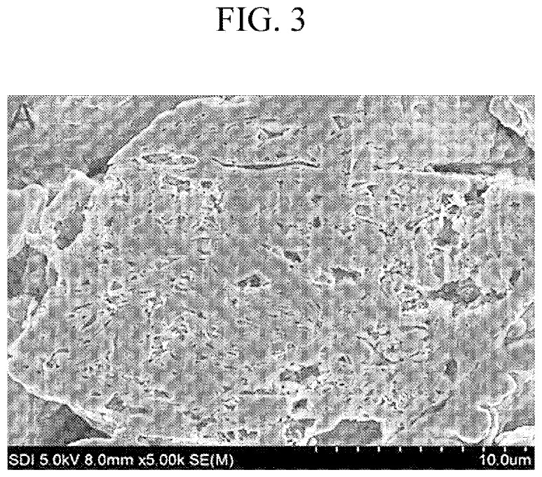

The SEM image for the negative active material according to Example 1 is shown in FIG. 3. As shown in FIG. 3, pores with an average size of 0.5 μm were formed in the negative active material.

### Experimental Example 2) Evaluation of Physical Properties of Negative Active Material

The X-ray diffraction analysis for the negative active materials according to Examples 1 to 5 and Comparative Examples 1 to 4 were conducted utilizing a CuKα ray.

The X-ray diffraction analysis was performed by utilizing a X'Pert (PANalytical B.V.) XRD equipment, but a monochromator equipment was removed in order to improve a peak intensity resolution. The measurement was performed under a condition of 2θ=20° to 80°, a scan speed (°/S)=0.06436, and a step size of 0.026°/step.

From these results, a length of an axis (La) and an interlayer d-spacing (d002), a peak intensity ratio, I(002), and a peak intensity ratio, I(110) were determined. Among these results, the length of the axis (La) and the interlayer d-spacing (d002) are shown in Table 1. The I(002)/I(110) was measured. The results are shown as O.I. (Orientation Index, I₀₀₂/I₁₁₀) in Table 1.

### Experimental Example 3) Evaluation of Area Ratio

The cross-section area of the negative active materials and the cross-section area of the pores formed in the negative active materials of Examples 1 to 5 and Comparative Examples 1 to 4 were determined by taking the SEM images which were treated by the cross-section CP, and measuring the areas of the carbon portions of the active material and the areas of the pores through the differences of the shadow ratio utilizing an Image J program, respectively. The ratios of the cross-section of pore/the cross-section area of active materials were determined. The results are shown in Table 1, as an area ratio (%).

### Experimental Example 4) Evaluation of High-Rate Charge Characteristic

The half-cells according to Examples 1 to 5 and Comparative Examples 1 to 4 were charged and discharged at 0.2 C once and charged and discharged at 2 C once. A ratio of charge capacity at 2 C relative to charge capacity at 0.2 C was measured. The results are shown in Table 1, as chargeabilty.

A particle diameter of the negative active materials of Examples 1 to 5 and Comparative Examples 1 to 4 are shown in Table 1.

TABLE 1

| | | Particle | | | | |
|---|---|---|---|---|---|---|
| | | diameter of | | | | |
| | Type of | negative | | | | |
| | graphite | active | Interlayer | | | |
| | raw | material | d-spacing | Area ratio | O.I. | Chargeability |
| | material | (D50, μm) | (d002, Å) | (%) | (I002/I110) | (2 C/0.2 C, %) |
| Example 1 | Amorphous | 22 | 3.372 | 7.91 | 98 | 35.0 |
| | graphite | | | | | |
| Example 2 | Amorphous | 22 | 3.362 | 4 | 113 | 33 |
| | graphite | | | | | |
| Example 3 | Amorphous | 22 | 3.364 | 6 | 104 | 33.8 |
| | graphite | | | | | |
| Example 4 | Amorphous | 22 | 3.368 | 7 | 98 | 34.2 |
| | graphite | | | | | |
| Example 5 | Amorphous | 22 | 3.378 | 10 | 84 | 35.5 |
| | graphite | | | | | |
| Comparative | Flaky | 20 | 3.354 | 8.01 | 130 | 24.2 |
| Example 1 | graphite | | | | | |
| Comparative | Amorphous | 22 | 3.361 | 3.5 | 118 | 30.4 |
| Example 2 | graphite | | | | | |
| Comparative | Amorphous | 22 | 3.38 | 10.5 | 82 | 32.9 |
| Example 3 | graphite | | | | | |
| Comparative | Amorphous | 22 | 3.36 | <1 | 115 | 21.3 |
| Example 4 | graphite | | | | | |

As shown in Table 1, the cells including the negative active materials of Examples 1 to 5 exhibited superior high rate charge characteristics to that of Comparative Examples 1 to 4.

The use of “may” when describing embodiments of the inventive concept refers to “one or more embodiments of the inventive concept.”

As used herein, the term “about,” and similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. An electronic apparatus, a battery management controlling device, a battery manufacturing device, and/or any other relevant devices or components according to embodiments of the present invention described herein may be implemented utilizing any suitable hardware, firmware (e.g. an application-specific integrated circuit), software, or a combination of software, firmware, and hardware. For example, the various components of the apparatus may be formed on one integrated circuit (IC) chip or on separate IC chips. Further, the various components of the apparatus may be implemented on a flexible printed circuit film, a tape carrier package (TCP), a printed circuit board (PCB), or formed on one substrate. Further, the various components of the apparatus may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

While this disclosure has been described in connection with what is presently considered to be practical example embodiments, it is to be understood that the present disclosure is not limited to the disclosed embodiments, but, on the contrary, is intended to cover various suitable modifications and equivalent arrangements included within the spirit and scope of the appended claims, and equivalents thereof.

What is claimed is:

1. A negative active material consisting of:
an amorphous carbon material,
low crystalline graphite particles, and
pores,
wherein,
the amorphous carbon material is around the low crystalline graphite particles and the pores, and
a ratio of a cross-sectional area of the pores relative to a cross-sectional area of the negative active material is about 4% to about 10%.

2. The negative active material as claimed in claim 1, wherein the negative active material has a peak intensity ratio, I(002)/I(110) measured by an X-ray diffraction analysis method of about 120 or less.

3. The negative active material as claimed in claim 1, wherein the negative active material has a peak intensity ratio, I(002)/I(110) measured by an X-ray diffraction analysis method of about 70 to about 120.

4. The negative active material as claimed in claim 1, wherein the negative active material is a form of particles having an average particle size of about 10 μm to about 25 μm.

5. The negative active material as claimed in claim 1, wherein the low crystalline graphite is derived from amorphous graphite.

6. The negative active material as claimed in claim 1, wherein the negative active material is prepared by:
pulverizing amorphous graphite to prepare graphite particulates;
agglomerating the graphite particulates by utilizing amorphous carbon to prepare an agglomerated product; and
mixing the agglomerated product with a pore-forming agent to form the pores.

7. The negative active material as claimed in claim 6, wherein the graphite particulates have an average particle size of about 10 μm or less.

8. The negative active material as claimed in claim 6, wherein the graphite particulates have an average particle size of about 0.1 μm to about 10 μm.

9. The negative active material as claimed in claim 6, wherein the pore-forming agent is an alkali-based activator.

10. The negative active material as claimed in claim 6, wherein the pore-forming agent is about 1 wt % to about 5 wt % in amount based on 100 wt % of the agglomerated product.

11. A rechargeable lithium battery, comprising:
a negative electrode comprising the negative active material of claim 1;
a positive electrode; and
an electrolyte.

12. A method of manufacturing the negative active material as claimed in claim 1, the method comprising:
pulverizing amorphous graphite to prepare graphite particulates;
agglomerating the graphite particulates by utilizing amorphous carbon to prepare an agglomerated product; and
mixing the agglomerated product with a pore-forming agent to form the pores.
